(19) United States
(12) Patent Application Publication
(10) Pub. No.: US 2021/0289642 A1
(43) Pub. Date: Sep. 16, 2021

(54) EXPLOSION-PROOF HOUSING HAVING PRESSURE-RELIEF MEANS

(71) Applicant: R. STAHL SCHALTGERÄTE GMBH, Waldenburg (DE)

(72) Inventor: Thorsten Arnhold, Pfedelbach (DE)

(21) Appl. No.: 17/258,094

(22) PCT Filed: Jun. 26, 2019
(86) PCT No.: PCT/EP2019/067068

§ 371 Date: Jan. 5, 2021

(30) Foreign Application Priority Data
Jul. 6, 2018 (DE) 10 2018 116 397.5

(51) Int. Cl. H05K 5/02

(52) U.S. Cl. CPC H05K 5/0213

(57) ABSTRACT

A housing that includes a pressure-relief body designed as a tubular body and extending through the interior of the housing. At least one end and preferably both ends of the pressure-relief body is or are connected to wall regions of the housing, such that the flow channel of the pressure-relief body is aligned with pressure-relief openings. This arrangement allows the construction of thin-walled and thus lightweight explosion-protected housings.

### CROSS REFERENCE TO RELATED APPLICATIONS

This application is a National Stage of PCT Application No. PCT/EP2019/067068 filed on Jun. 26, 2019, which claims priority to German Patent Application No. 10 2018 116 397.5 filed on Jul. 6, 2018, the contents each of which are incorporated herein by reference thereto.

### TECHNICAL FIELD

The invention refers to a housing for enclosing elements that could form ignition sources, wherein the housing is suitable for use in explosive environments.

### BACKGROUND

Explosion-proof housings are known in different configurations. Typically such housings are provided with at least one pressure relief opening at which a flame arrestor is arranged. For example GB 778040 shows such a housing comprising a rectangular pressure relief opening at which a flame arrestor in the form of a porous body is clamped by means of a clamping frame.

Also U.S. Pat. No. 4,180,177 A illustrates an explosion-proof housing having a pressure relief opening in which a porous body is arranged forming a flame arrestor. The pressure relief opening can be covered by a movably supported cover.

As shown in DE 10 2005 042 565 B4, it has also been proposed to form an explosion-proof housing completely of a material that is gas permeable, but flame arresting due to its porosity. The housing then comprises a tube or cup-shaped housing part that forms the housing wall and separates the inner space from the environment.

In addition, DE 10 2006 048 943 A1 discloses a pressure compensation cylinder having a tube membrane. The tube membrane consists of a porous material and is therefore gas permeable. It is held on both ends in the pressure compensation cylinder, wherein the pressure compensation cylinder comprises inlet openings on one end and a gas exit opening at its other end. In the pressure compensation cylinder also multiple of such tube membranes can be held.

### BRIEF SUMMARY

It is the object of the invention to create a housing for enclosing of elements that could form ignition sources, wherein the underlying concept shall also be suitable for particularly large housings.

A housing for enclosing elements that could form ignition sources, for the use in explosive environments, including: a wall arrangement that encloses an inner space in which the elements are located, the wall arrangement having at least one pressure compensation opening; and a tube-shaped pressure compensation body arranged at the pressure compensation opening and projecting in the inner space.

The housing according to the invention allows the use of pressure compensation bodies the gas permeable surface of which is larger than the cross-section of the pressure relief opening. Thereby it is possible to oppose only a particularly low flow resistance to the gas volume that has to be channeled out of the housing and that was created during an explosion occurring in the housing, which counteracts the development of a pressure peak in the housing. Thereby the wall thickness of the respective housing can be reduced without endangering the safety and integrity of the housing.

The pressure compensation body is arranged directly in the inner space of the housing, which particularly means that it is not enclosed separately. This also contributes to avoid a reduction of the required pressure-compensating gas flow. On the other hand, the pressure compensation body is protected from environmental influences in the inner space. Because only a small cross-section is required for the pressure compensation opening, the mechanical stability of the housing wall is not affected by the pressure compensation opening.

The pressure compensation body can be configured and arranged as to cross the inner space completely in a first embodiment. Thereby it adjoins preferably with its two ends a pressure compensation opening respectively and thus adjoins two pressure compensation openings in total. This concept allows the use of pressure compensation openings with particularly small cross-section and is particularly suitable also for the use in substantially large housings.

It is, however, also possible to configure the pressure compensation body with only one open end in a cup-shaped manner, wherein its open end adjoins the pressure compensation opening and its closed end extends in the inner space.

The pressure compensation body is mechanically connected with the wall arrangement of the housing at the pressure compensation opening. For this the pressure compensation body can be preferably welded to the edge of the pressure compensation opening, preferably by means of a ring-shaped weld seam. For this the tube-shaped pressure compensation body can extend through the pressure compensation opening or can abut against the face side at the inner side of the housing wall. The weld seam connecting the pressure compensation body with the housing wall can be provided at the inner side of the housing wall or at the outer side thereof. It is also possible to hold the tube-shaped pressure compensation body in a base that in turn is connecting with the housing wall. For holding the pressure compensation body in the base, the pressure compensation body can be connected with the base, particularly in a material bond manner, e.g. by gluing, welding or brazing. The base can be glued, welded or screwed to the housing.

The pressure compensation opening can be closed by a protection device, such as for example a bursting disc, a cover, a membrane or a plug, wherein this protection device opens depending on the pressure. The protection device is preferably formed by a closure that seals the pressure compensation opening in an insect-protected manner and blocks the ingress of humidity or water.

The pressure compensation body is configured in a cup-shaped or tube-shaped manner. Any pressure compensation body is considered to be a tube-shaped pressure compensation body surrounding a pressure compensation channel having a wall that is at least partially gas permeable. The cross-section of this pressure compensation body can be contoured in a round or polygonal manner. For example, the pressure compensation body can be formed by a rectangular tube that comprises one or more cutouts at its flanks that are closed by flat pressure compensation elements respectively. They can be welded, glued, screwed or otherwise attached to the rectangular tube. It is also possible to form the pressure compensation body completely of gas permeable material. The gas permeable material can be, for example, metal, a metal alloy, ceramic, glass or a non-flammable organic rigid material or a mixture of the mentioned materials. The material comprises pores and can be provided in the form of foam, in the form of wires entangled and/or glued and/or sintered with each other, in form of powder or particles that are connected with each other by gluing, soldering, sintering, welding or by mechanical bond. Fibers, threads, wires, particles or the like can also be held in the form of a loose filling in a housing, wherein the filled housing forms the pressure relief body.

### BRIEF DESCRIPTION OF THE DRAWINGS

Advantageous details of the invention are apparent from the drawings, the respective description or the dependent claims. The drawings show:

FIG. 1 the housing according to the invention in a simplified perspective illustration,

FIG. 2 the housing of FIG. 1 in simplified vertically cut illustration,

FIG. 3 an embodiment of a pressure relief body in a cross-sectional illustration,

FIG. 4 an alternative embodiment of a pressure relief body in a cross-sectional illustration and

FIGS. 5 to 10 further embodiments of a housing according to FIG. 1 in a simplified vertically cut illustration respectively.

### DETAILED DESCRIPTION

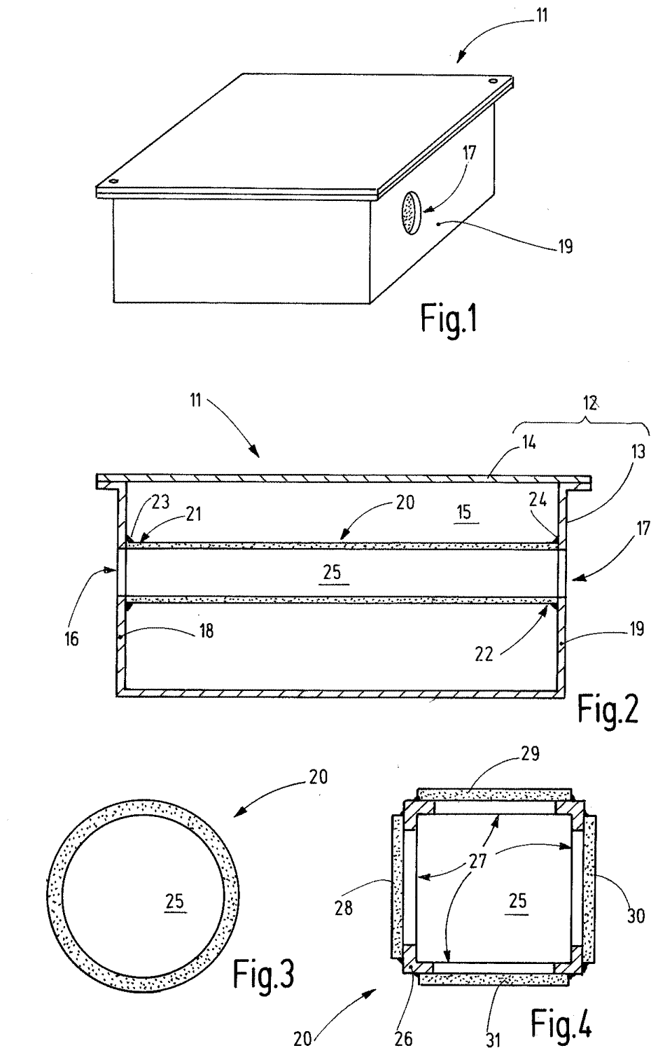

FIG. 1 illustrates a housing 11 that is configured for the use in explosive environments. The housing 11 serves to enclose components, e.g. electronic or electric components that can form ignition sources for an explosive gas mixture during operation. For enclosing such components, the housing 11 is formed by a wall arrangement 12, as shown in FIG. 2, a housing body 13 and a cover 14 forming part thereof. The wall arrangement 12 encloses an inner space 15 in which the components mentioned above can be arranged. The inner space can have a volume of multiple liters up to multiple 100 liters. In general this housing concept can, however, also be used for smaller housings.

For example, the wall arrangement 12 comprises in the region of the housing body 13 or also on the cover 14 at least one and preferably two pressure relief openings 16, 17 that are preferably arranged on two wall sections 18, 19 arranged parallel to one another. The pressure relief openings 16, 17 are preferably aligned to each other. Between the wall sections 18, 19 a pressure relief body 20 is arranged that is formed completely or partly of a gas permeable porous, but flame-retarding material and bridges the distance between the wall sections 18, 19. For example, the pressure relief body can consist of sintered metal balls, metal powder, several wire fabric layers placed on top of each other and wound to form a tube or the like. The pressure relief body 20 is configured in a tube-shaped manner (e.g. as round tube or as tube with polygonal cross-section) and connected with a wall arrangement 12, specifically with the first wall section 18 and the second wall section 19 at its two ends 21, 22. Thereby the pressure relief body 20 can be configured as cylindrical tube as obvious from FIG. 3 that abuts with its faces at the inner side of the wall sections 18, 19 and is connected with the wall sections 18, 19 there, e.g. by means of ring-shaped weld seams 23, 24.

The pressure relief body 20 comprises pores, the width and the length thereof is so large, such that flames cannot escape from the inner space 15 in the inner flow channel 25 of the pressure relief body 20. Also no glowing particles can escape in the flow channel 25 in this way. The flow channel 25 leads to the outside via the two pressure relief openings 16, 17. The pressure relief body 20 can be formed of metallic or non-metallic material. The respective material such as metal, ceramic, glass or the like provided as particles, balls, threads or foam can be formed to a rigid body by sintering, gluing or mechanical bonding.

The concept of the tube-shaped pressure relief body 20 can also be realized in the form of a polygonal tube, as illustrated in FIG. 4 by means of a rectangular tube. The pressure relief body 20 according to FIG. 4 consists of a rectangular tube 26 with rectangular or square cross-section that comprises gas escape openings 27 at its flanks that establish a connection between the inner space 15 and the flow channel 25 transverse to the flow direction defined by the flow channel 25. The gas escape openings 27 are provided with flame protection filters 28, 29, 30, 31 that can be preferably configured as flat plates. These flame protection filters 28-31 can be formed of metallic or ceramic material or glass, just like the pressure relief body 20 according to FIG. 3 that is provided in the form of particles, balls, fibers or a mixture of these forms and is bonded by mechanical connection, sintering or gluing to a rigid body. The flame protection filters 28-31 comprise gas escape openings in the form of pores that are so narrow and long, such that flames and glowing particles cannot pass therethrough.

Whereas the flame protection filters 28-31 according to FIG. 4 are attached to a rectangular tube serving as a carrier, it is also possible to connect plate-shaped flame protection filters without the aid of a carrier directly with each other, e.g. by welding.

The pressure relief body 20 according to FIG. 4 can be used instead of the pressure relief body 20 according to FIG. 3 in each of the above or below described embodiments. Also the shape can be selected differently. Instead of a rectangular tube 26 also other tubes with polygonal cross-section, e.g. triangular cross-section, pentagonal cross-section, hexagonal cross-section, etc. can be provided. It is also possible to configure the pressure relief body 20 according to FIG. 3 with a cross-section deviating from the circular shape, e.g. a triangular cross-section, rectangular cross-section, pentagonal or hexagonal cross-section, etc.

The housing 11 described so far works as follows:

During use the cover 14 is firmly connected with the housing body, whereby respective connection means such as clamps, screws or the like are not illustrated in FIGS. 1 and 2. In the inner space 15 components are located that can form ignition sources, such as for example relays, transistors, resistors or the like elements that can heat during operation. If the housing 11 is located in an explosive atmosphere, flammable or explosive gases can enter the inner space 15. If they are ignited there, the occurring deflagration results in an expansion of the involved gases. They flow through the pressure relief body 20 into the flow channel 25 and from there via the pressure relief openings 16, 17 to the outside being cooled thereby. When passing through the pressure relief body 20, the gases are cooled so far that the gases reaching the flow channel 25 do not form an ignition source for the explosive environment anymore.

Due to the large surface of the pressure relief body, it forms only a small flow resistance for the expanding gases such that the pressure increase in the inner space 15 can be limited to small amounts during an occurring deflagration.

The connection between the wall sections 18, 19 by means of the pressure relief body 20 can have an effect stabilizing the housing. This applies particularly to thin-walled housings with large volume. The tensile strength of the pressure relief body can be used to prevent bulging of the wall sections 18, 19.

The housing 11 can comprise multiple pressure relief bodies 20 according to any of the configurations described above or below. This applies particularly to housings of large volumes, such as control cabinets or the like.

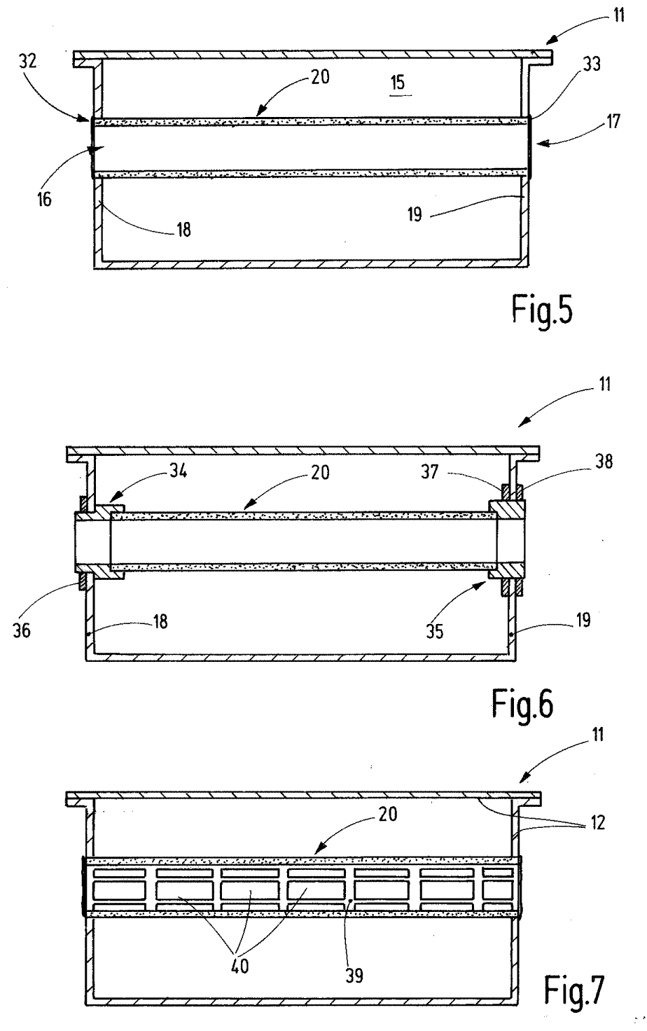

FIG. 5 illustrates a modified embodiment of the housing 11. As apparent, the pressure relief body 20 extends through the two pressure relief openings 16, 17 formed in the wall sections 18, 19. For connection between the pressure relief body 20 and the respective wall section 18, 19 a respective ring-shaped weld seam 32, 33 can be provided that surrounds the end of the pressure relief body 20 or a not illustrated collar enclosing the respective end connecting the end or the collar with the respective wall section 18, 19. The advantage of this embodiment is the improved accessibility of the connection between the pressure relief body 20 and the wall section 18, 19, for example during creation of the weld seam 32, 33. This configuration is suitable for all types of pressure relief bodies 20 mentioned and described above or below.

FIG. 6 illustrates another modified embodiment of the housing 11. The pressure relief body 20 is held in bases 34, 35 that in turn are connected with the respective wall section 18, 19. For example, the base 34 can hold the pressure relief body at a respective seat and for this can be connected with the pressure relief body 20 mechanically, e.g. by means of clamps, screws, as well as in a material-bond manner, for example by gluing or welding or soldering. The base 34 can extend through the pressure relief opening of the wall section 18 and can be connected with the wall section 18 in a material-bond manner, e.g. by welding or for example by means of a nut 36 in a form-fit manner.

Preferably the opposing housing wall comprises an opening in the wall section 19 having a diameter that is larger than the outer diameter of the base 34. Thus, it can be inserted through the opening of the wall section 19. For securing the base 35 on the wall section 19, multiple nuts 37, 38 can be screwed on the outer thread of the base 35, for example. It is, however, also possible to weld the base 35 to the wall section 19.

In the embodiment according to FIG. 7 the pressure relief body 20 can be attached to the wall arrangement 12 in any manner mentioned above or below. The pressure relief body 20 being, for example hollow cylindrically, can however comprise a support tube 39, the wall of which comprises a plurality of large area openings 40, whereby the porous material of the pressure relief body abuts against the support tube 39 from the outside. The support tube 39 can stiffen the pressure relief body 20 and increase its mechanical stability.

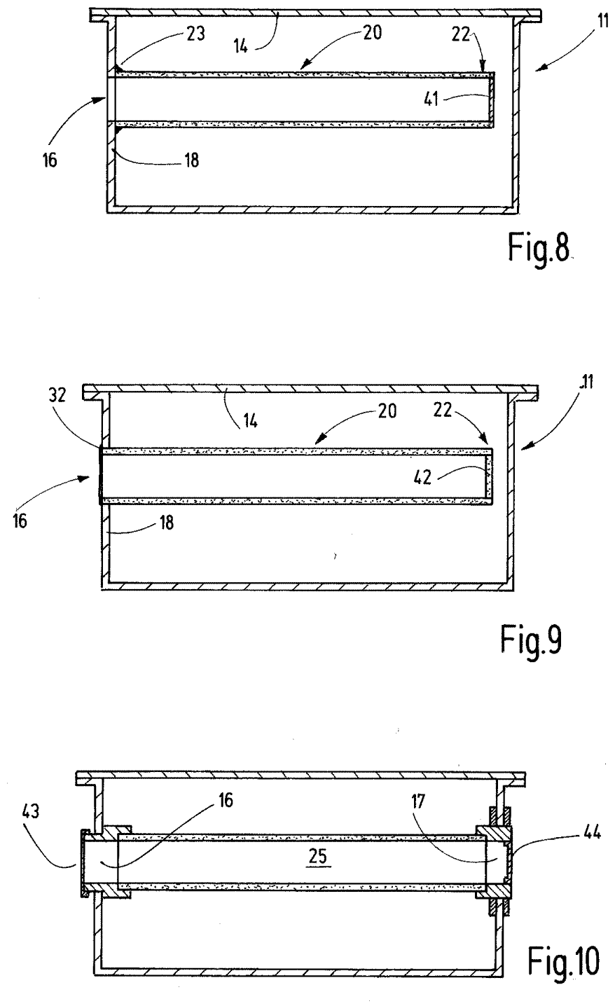

It is also possible to configure the housing 11 such that the pressure relief body 20 communicates with only one pressure relief opening 16 and is closed at its end 22 facing away therefrom, as illustrated in FIGS. 8 and 9. They only serve as exemplary illustration and show modifications of the type of attachment compared with FIGS. 2 and 5 in which the pressure relief body 20 is attached to the wall section 18 with a weld seam 23 or 32 on the inner or outer side respectively. Each other described type of connection, for example in the manner by means of a base 34 or a base 35 according to FIG. 6, can also be used. The end 22 opposed to the pressure relief opening 16 can be closed by means of a rigid non-gas permeable closure 41 or also by means of a gas permeable bottom 42. This type of arrangement of pressure relief bodies 20 in housings 11 is particularly suitable for housings in which a pressure relief body 20 crossing the inner space completely would be disturbing or in which the one or the more pressure relief bodies 20 have to be connected to pressure relief openings that extend through the cover 14. In addition, two or more of such pressure relief bodies 20 open at one side can be provided in order to be arranged at pressure relief openings provided at different locations of the cover 14 and/or the housing body 13.

In each of the embodiments described above, the pressure relief opening 16 and/or 17 can be provided with a closure 43, 44. The closure can be any type of a mechanical means that blocks the ingress of insects, dirt and/or humidity in the flow channel 25, on the other hand however does not or not continuously impede the escape of gas therefrom. Such closures 43, 44 can be caps that can be plugged, latched or screwed, as illustrated in FIG. 10 by the example of the closure 43. Such caps are particularly configured that they can be blasted away, ripped or opened in any other manner, if a sufficient overpressure is present in the flow channel 25. The closure can also be a blocking element inserted in the pressure relief opening, as illustrated in FIG. 10 by the example of closure 44 in the pressure relief opening 17. The closure can be an element that is held in the pressure relief opening 17 in a form-fit manner, by a material bond or in any other manner that is pushed out of the pressure relief opening 17 or is ripped itself and releases the flow path in this manner in case of an overpressure in the flow channel 25. Also pivotable flaps or the like can be provided instead of blastable or rippable closure elements.

The inventive housing 11 comprises a pressure relief body 20 that is configured as tube body and that extends through the inner space 15 of the housing 11. The pressure relief body 20 is connected with at least one end 21 and preferably with its two ends 22 with wall sections 18, 19 of the housing 11 such that its flow channel is aligned with pressure relief openings 16, 17. This arrangement allows the construction of thin-walled and thus light-weight explosion-proof housings 11.

### LIST OF REFERENCE SIGNS

11 housing
12 wall arrangement
13 housing body
14 cover
15 inner space
16 first pressure-relief opening
17 second pressure-relief opening
18 first wall section
19 second wall section
20 pressure-relief body
21 first end of pressure-relief body
22 second end of pressure-relief body
23, 24 weld seams
25 flow channel
26 rectangular tube
27 gas escape openings
28-31 flame protection filter
32, 33 weld seam
34 first base
35 second base
36-38 nuts
39 support tube
40 openings
41 gas permeable closure
42 gas permeable bottom
43 first closure
44 second closure

1. A housing for enclosing elements that could form ignition sources, for the use in explosive environments, comprising:
a wall arrangement that encloses an inner space in which the elements are located, the wall arrangement having and that comprises at least one pressure compensation opening; and
a tube-shaped pressure compensation body arranged at the pressure compensation opening and projecting in the inner space.

2. The housing according to claim 1, wherein the pressure compensation body is arranged in a manner that completely crosses the inner space.

3. The housing according to claim 1, wherein the wall arrangement comprises a second pressure compensation opening and the pressure compensation body is held between the at least one pressure compensation opening and the second pressure compensation opening.

4. The housing according to claim 3, wherein the pressure compensation body is connected to the at least one pressure compensation opening and the second pressure compensation opening.

5. The housing according to claim 1, wherein the pressure compensation body is welded to the wall arrangement.

6. The housing according to claim 1, wherein at least with one end of the pressure compensation body is connected to the wall arrangement with a base body.

7. The housing according to claim 1, wherein the pressure compensation body is a tube body made of a porous material.

8. The housing according to claim 1, wherein the pressure compensation body is a tube of a non-porous material having at least one radial opening at which at least one pressure compensation body made of a porous material is arranged.

9. The housing according to claim 1, wherein the pressure compensation opening is provided with a closure.

10. The housing according to claim 1, wherein the wall arrangement comprises a first pressure compensation opening having a first diameter located in one of a pair of opposed wall sections and a second pressure compensation opening having a second diameter located in the other one of the pair of opposed wall sections, wherein the first diameter is different from the second diameter.

11. The housing according to claim 2, wherein the wall arrangement comprises a second pressure compensation opening and the pressure compensation body is held between the at least one pressure compensation opening and the second pressure compensation opening.

12. The housing according to claim 11, wherein the pressure compensation body is connected to the at least one pressure compensation opening and the second pressure compensation opening.

13. The housing according to claim 12, wherein the pressure compensation body is welded to the wall arrangement.

14. The housing according to claim 13, wherein at least with one end of the pressure compensation body is connected to the wall arrangement with a base body.

15. The housing according to claim 14, wherein the pressure compensation body is a tube body made of a porous material.

16. The housing according to claim 15, wherein the pressure compensation body is a tube of a non-porous material having at least one radial opening at which at least one pressure compensation body made of a porous material is arranged.

17. The housing according to claim 16, wherein the pressure compensation opening is provided with a closure.

18. The housing according to claim 17, wherein the wall arrangement comprises a first pressure compensation opening having a first diameter located in one of a pair of opposed wall sections and a second pressure compensation opening having a second diameter located in the other one of the pair of opposed wall sections, wherein the first diameter is different from the second diameter.

19. The housing according to claim 2, wherein the pressure compensation body is welded to the wall arrangement.

20. The housing according to claim 19, wherein at least with one end of the pressure compensation body is connected to the wall arrangement with a base body.
